(19) United States
(12) Patent Application Publication
(10) Pub. No.: US 2002/0132086 A1
(43) Pub. Date: Sep. 19, 2002

(54) Sweat-absorbing and non-slip pad

(76) Inventor: Hsu Tang Su-Tuan, Tao Yuan City (TW)

Correspondence Address: POWELL, GOLDSTEIN, FRAZER & MURPHY LLP, P.O. BOX 97223, Washington, DC, 20090-7223, US

(21) Appl. No.: 09/811,691

(22) Filed: Mar. 19, 2001

(51) Int. Cl. B32B 3/00; B32B 5/02; B32B 9/00; D04H 11/00; B32B 33/00; B32B 27/04

(52) U.S. Cl. 428/96; 428/85; 442/59; 442/101

(57) ABSTRACT

A sweat-absorbing and non-slip pad is disclosed. The present invention includes a surface cloth and an underlying non-slip material. A non-slip paste forming said non-slip material is coated on the bottom surface of the cloth using spraying or spreading until an appropriate thickness is provided, and then pressed to shape and from the non-slip material on the bottom surface of the cloth. Among these, the non-slip paste is formed by mixing and melting an adhesive binder and PVC material. The adhesive binder including plastic powder, plasticizer, stabilizer and foaming agent, thereby providing stickiness and fine protrusions for enhancing non-slip ability. Additionally, the cloth includes a surface woolenette layer and having an underlying base. The permeated portion in the base caused by the non-slip material never oozes form the base so as to not affect the woolenette layer. Therefore, the present invention is sweat-absorbing and enables the user to feel comfortable because the cloth incompletely absorbs the non-slip material.

### BACKGROUND OF THE INVENTION

1. Field of the Invention

The present invention relates to a sweat-absorbing and non-slip pad.

2. Description of the Prior Art

Generally, the conventional non-slip pad merely owns basic non-slip function and positioned under the object. The conventional non-slip pad is non-sweat-absorbing and thus not suitable for serving as the sporting pad. If the surface of the non-slip pad does not absorb the sweat, the user may slip and feel uncomfortable due to moistness. Furthermore, in this case, the user may catch a cold. If the sport, such as yoga, on the non-slip pad is both dynamic and static, the user's skin may break out in a rash due to contacting sweat frequently.

To overcome the aforementioned problems, a non-slip pad having a cloth formed on the surface is proposed. Such the non-slip pad is both non-slip and sweat-absorbing. However, the conventional non-slip pad, having the cloth formed on the upper surface and the non-slip material formed on the bottom surface, still includes the disadvantages as follows. Since the cloth is attached to the non-slip material merely by adhesion, the cloth may peel off the non-slip material during using since the cloth is attached to the non-slip material merely by adhesion. The cloth tends to completely absorb the non-slip material, as a result, the condensed non-slip material coated on the cloth obstructs absorbing water.

Moreover, the cloth may include the woolenette layer and the base. The underlying base of the woolenette layer is thin, so that the non-slip material is fully absorbed by the cloth. Furthermore, the non-slip material tends to ooze from the woolenette layer. As a result, the originally soft woolenette layer becomes harsh due to the condensed non-slip material. The user may feel uncomfortable during using.

Additionally, the conventional non-slip pad based on the defective provides poor non-slip ability. The conventional non-slip pad may slide due to the violent sport on the pad. it is possible that the user slips and thus injured.

### SUMMARY OF THE INVENTION

Therefore, the main object of the present invention is to provide a sweat-absorbing and non-slip pad can overcome the aforementioned problems, thereby absorbing sweat and preventing the user on the present invention from sliping.

The second object of the present invention is to provide a method for forming sweat-absorbing and non-slip pad. According to the method, the fine protrudent objects are formed on the bottom surface of the non-slip material, thereby enhancing the non-slip ability.

The third object of the present invention is to provide a method for forming sweat-absorbing and non-slip pad. Such the method prevents the cloth from excessively absorbing the underlying non-slip material. Besides, the boding between the cloth and the non-slip material is maintained to avoid peeling off and expand its lifetime.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 shows a front perspective view illustrating the present invention;

FIG. 2 shows a partially enlarged view of the present invention shown in FIG. 1;

FIG. 3 shows a rear perspective view illustrating the present invention;

FIG. 4 shows a partially enlarged view of the present invention shown in FIG. 3;

FIG. 5 shows a partially bottom view of the present invention shown in FIG. 1; and

FIG. 6 shows another method for forming the non-slip material on the bottom surface of the cloth.

### DESCRIPTION OF THE PREFERRED EMBODIMENT

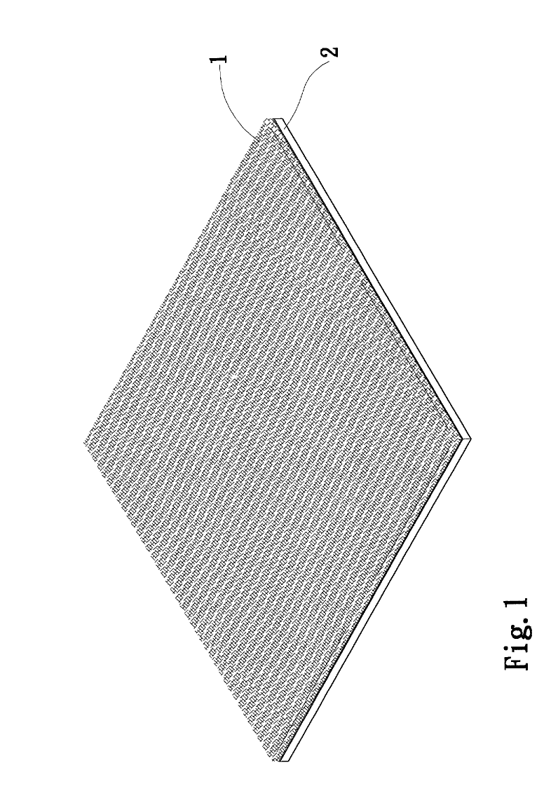

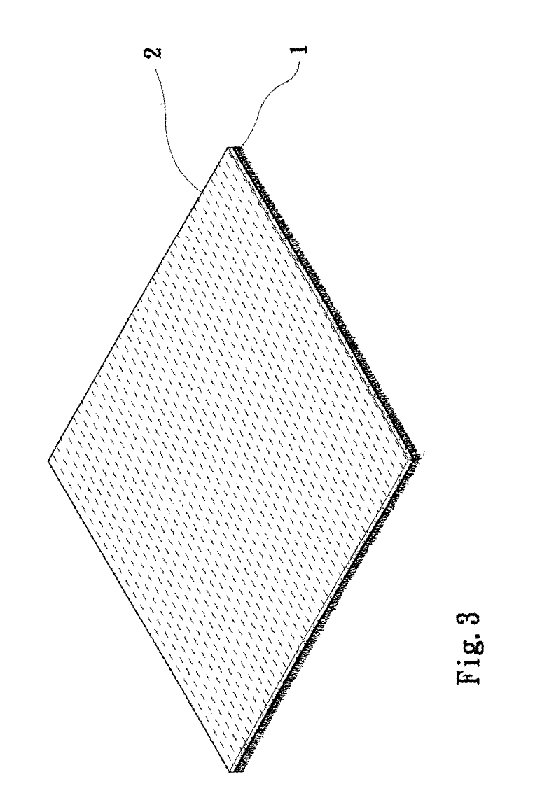

The present invention provides a sweat-absorbing and non-slip pad. Referring to FIG. 1 through FIG. 4, according to the present invention, the sweat-absorbing and non-slip pad is composed of the surface cloth 1 and the underlying non-slip material 2. Among these, the cloth 1 can be chosen from any suitable material. The non-slip material 2 may be semiliquid non-slip paste before cooling.

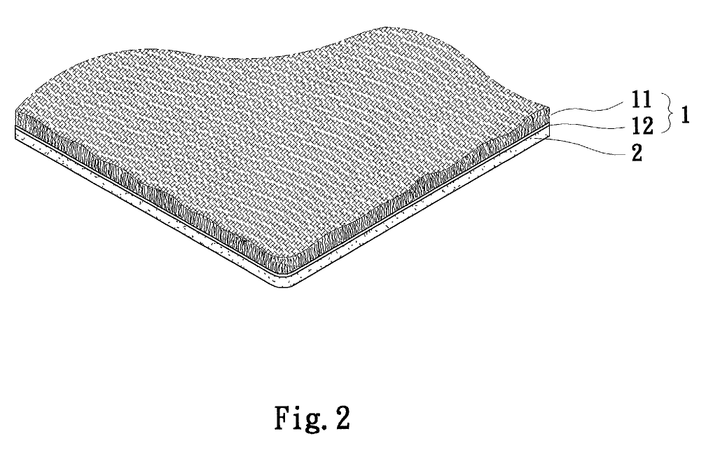

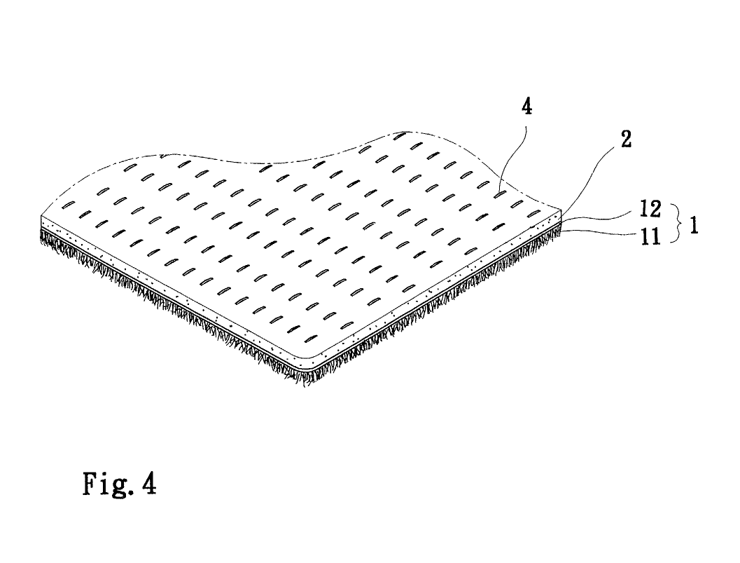

During processing, the non-slip paste is coated on the bottom surface of the cloth 1 using spraying or spreading until an appropriate thickness is provided, and then pressed to shape. After cooling, the present non-slip pad is completed. Besides, as shown in FIG. 2 and FIG. 4, the fine protrudent objects, i.e. the protrusions 4, are formed on the bottom surface of the non-slip material 2. In this manner, the non-slip material 2 can properly or incompletely permeate into the cloth 1 so as to enable the cloth 1 be sweat-absorbing. Therefore, by means of the underlying non-slip material 2 and the surface cloth 1, the present invention is enabled to be non-slip and sweat-absorbing, respectively. During user sweating and using the present invention as the sporting pad or the yoga pad, the present invention can absorb sweat, thereby avoid slipping.

The non-slip paste is fabricated by the steps as follows. The adhesive binder is added to the dissolving PVC material and then melted and mixed completely. The adhesive binder further includes plastic powder (45%), plasticizer (52.5%), stabilizer (1.5%) and foaming agent (2%).

The finished product based on the above processing steps generates stickiness and non-slip ability due to its specific composition. Besides, the fine protrusions 4 formed on the bottom surface of the non-slip material 2 according to the present processing method enhances friction against the ground, thereby providing further non-slip ability. In addition, the present specific configuration provides toughly bonding between the cloth 1 and the non-slip material 2 to avoid peeling off and thus expanding its lifetime.

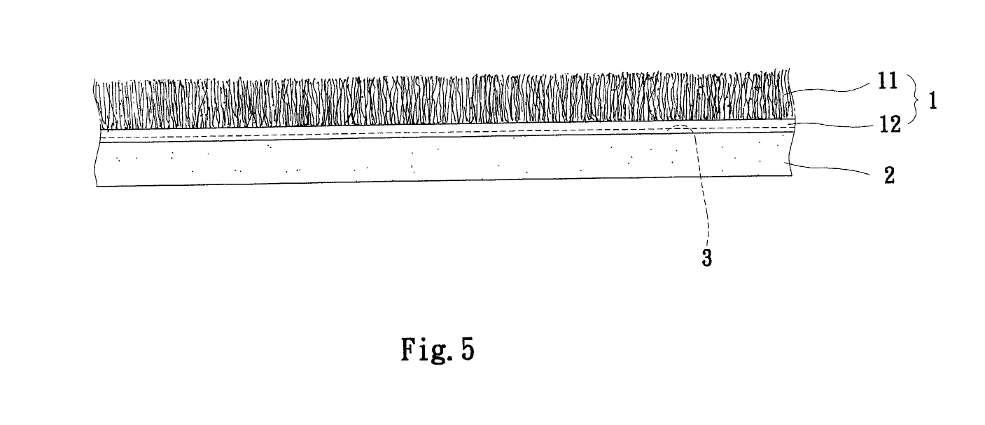

Any cloth, such as the water-absorbing cloth, is suitable for present invention. However, it is preferred that the cloth 1 is the cloth having the woolenette for user comfort. Referring to FIG. 5, the chosen cloth 1 includes the woolenette layer 11 and the base 12. If the non-slip material 2 is not formed by the present method, the permeated portion 3 of the non-slip material 2 tends to ooze from the base 12 and condense on the woolenette layer 11 since the underlying base 12 is very thin, as shown in FIG. 5. As a result, the originally soft woolenette layer 11 becomes harsh. During using such the pad as the sporting pad or yoga pad contacting with the skin, the user may feel uncomfortable and has a pain. Moreover, the sweat-absorbing ability is reduced significantly because the excessive permeated portion 3 formed in the woolenette layer 11.

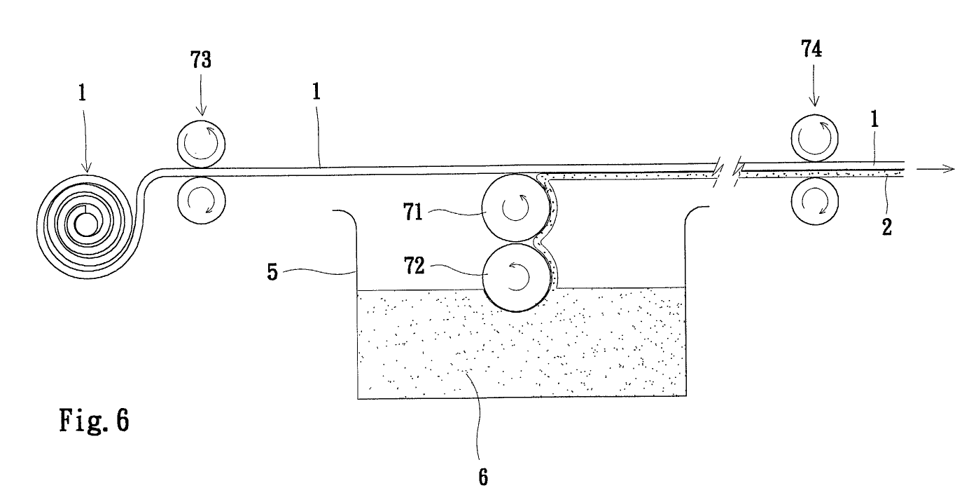

Still referring to FIG. 5, besides the foregoing processing steps for forming the present non-slip pad and preventing the permeated portion 3 of the non-slip material 2 from oozing from such the thin base 12, the present invention still includes another method for the same purpose. According to the present invention, the method shown in FIG. 6 is also acceptable. Referring to FIG. 6, the front and rear roller modules, i.e. the front roller module 73 and the rear roller module 74, are provided above the container 5 containing the above-mentioned non-slip paste 6 or any suitable paste non-slip after cooling. A roll of cloth 1 is unfolded and spread by the front roller module 73 and the rear roller module 74. The front roller module 73 and the rear roller module 74 are composed of the upper roller and the lower roller opposite to each other, respectively. In this manner, the cloth 1 or the non-slip pad interposed between the upper roller and the lower roller of the front roller module 73 or the rear roller module 74 is pulled backward by means of the rolling upper and lower rollers. The front roller module 73 clamps and pulls the cloth 1. Then, the rear roller module 74 clamps and pulls backward the cooled non-slip pad having the non-slip material 2 already formed thereon. The bottom of the cloth 1 interposed between the front and rear roller modules 73, 74 is soaked in the non-slip paste 6 contained in the container 5 by the opposite upper and lower feed rollers 71, 72 so as to form the non-slip material 2 of the non-slip pad. Half the lower feed roller 72 is soaked in the non-slip paste 6 contained in the container 5. In this case, the non-slip paste 6 is absorbed by the surface of the lower feed roller rolling anti-clockwise. The synchronal upper feed roller 71 also rolling anti-clockwise is slightly isolated from the lower feed roller 72 so as to form a narrow interval. The synchronal upper and lower feed rollers 71, 72 rolling in the same direction constitute two opposite rolling tangential directions formed in the adjacency thereof. Besides, the rolling tangential direction in the adjacency between the upper feed roller 71 and the bottom surface of the cloth 1 is opposite to the moving direction of the cloth 1. In this manner, after the right side of the lower feed roller 72 absorbs the non-slip paste 6, the right side of the upper feed roller 71 thus absorbs the non-slip paste 6. Further, since the upper periphery of the upper feed roller 71 contacts the bottom of the cloth 1, the non-slip paste 6 absorbed by the right side of the upper feed roller 71 is transferred to the bottom of the cloth 1. After cooling, the result structure is further clamped and pulled backward by the rear roller module 74 so as to gather and form the non-slip pad. The non-slip material formed on the bottom of the cloth 1 according to the method shown in FIG. 6 can prevent the permeated portion 3 from oozing form the base 12 of the cloth 1. That is, the woolenette layer 11 of the cloth 1 maintains soft. It is comfortable for the user using the present invention positioned under the blanket as a sporting pad or a yoga pad because the present invention is not harsh. Additionally, the present invention is more sweat absorbing than prior art. To sum up, the present invention provides a sweat-absorbing and non-slip pad improving the conventional advantages including non-sweat-absorbing. Besides, in the present invention, the permeated portion 3 never oozes form the base 12 of the cloth 1. That is, the woolenette layer maintains soft and comfort, and the cloth including the woolenette layer and the base is sweat-absorbing. The present invention meets the requirement of the novelty and non-obviousness.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A sweat-absorbing and non-slip pad having a surface cloth and an underlying non-slip material, is characterized as:
a non-slip paste forming said non-slip material being coated on the bottom surface of the cloth using spraying or spreading until an appropriate thickness is provided, and then pressed to shape and from the non-slip material on the bottom surface of the cloth.

2. The sweat-absorbing and non-slip pad according to claim 1, wherein said non-slip paste is formed by mixing and melting an adhesive binder and PVC material, said adhesive binder including plastic powder (45%), plasticizer (52.5%), stabilizer (1.5%) and foaming agent (2%), thereby providing stickiness and avoid slip.

3. The sweat-absorbing and non-slip pad according to claim 1, wherein said non-slip material further includes fine protrusions formed on the bottom surface, thereby increasing friction against the ground and providing further non-slip ability.

4. The sweat-absorbing and non-slip pad according to claim 1, wherein said cloth further includes a woolenette layer and an underlying base, a permeated portion of said non-slip material being prevented from oozing from said base and said woolenette layer.

5. A sweat-absorbing and non-slip pad having a surface cloth and an underlying non-slip material, is characterized as:
a non-slip paste forming said non-slip material being upward coated on said cloth according a direction opposite to a moving direction of said cloth, thereby forming said non-slip material on a bottom surface of said cloth after cooling.

6. The sweat-absorbing and non-slip pad according to claim 5, further comprises a container containing said non-slip paste forming said non-slip material, said cloth being pulled and moved laterally above said container; a upper and a lower feed rollers being provided above container contained in said container, said lower feed roller being soaked in the non-slip paste, said upper feed roller being slightly isolated from said lower feed roller, said upper feed roller and said lower feed roller having the same rolling direction, said upper feed roller being adjacent to a bottom of said cloth, rolling tangential directions in the adjacency between said upper feed roller and said lower feed roller being opposite to each other, rolling tangential direction in the adjacency between said upper feed roller and said cloth being opposite to a moving direction of said cloth, thereby transferring said non-slip paste absorbed by said lower feed roller to a bottom of said cloth by said upper feed roller and said bottom of said cloth.

7. The sweat-absorbing and non-slip pad according to claim 5 or 6, wherein said cloth comprises a surface woolenette layer and having an underlying base, a permeated portion in said base caused by said non-slip material never oozing form said base so as to not affect said woolenette layer.

8. A sweat-absorbing and non-slip pad having a surface cloth and an underlying non-slip material, is characterized as:
said cloth comprises a surface woolenette layer and having an underlying base, a permeated portion in said base caused by said non-slip material never oozing form said base so as to not affect said woolenette layer.
